(19) United States
(12) Patent Application Publication
(10) Pub. No.: US 2004/0151503 A1
(43) Pub. Date: Aug. 5, 2004

(54) Communication system having wireless transmission path and optical transmission path

(75) Inventors: Masayuki Kashima, Tokyo (JP); Saeko Oshiba, Kyoto (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/761,197

(22) Filed: Jan. 22, 2004

(30) Foreign Application Priority Data
Jan. 27, 2003 (JP) 017181/2003

(51) Int. Cl. H04B 10/00

(52) U.S. Cl. 398/115

(57) ABSTRACT

A central station and base station are connected by using an optical transmission path. Low frequency optical signals are transmitted via the optical transmission path. The base station and a wireless terminal are connected by using a wireless transmission path. The base station converts an optical signal that is input via the optical transmission path into an electrical signal, converts the electrical signal into a high frequency signal, and then converts this high frequency signal into a radio wave signal and outputs this signal. The wireless terminal inverts the received radio wave into an electrical signal and converts the electrical signal into a low frequency signal. By using low frequency optical signals and high frequency electrical signals, the costs of building the communication system can be reduced without any loss of communication speed.

### BACKGROUND OF THE INVENTION

1. Field of the Invention

The present invention relates to a communication system that has both a wireless transmission path and an optical transmission path. The communication system of the present invention can be adopted in a mobile communication system and in FTTx (Fiber To The x) and so forth, for example.

2. Description of Related Art

Mobile communication systems, for example, are known as communication systems that have both a wireless transmission path and an optical transmission path. In addition, so too in optical access systems that are collectively known as FTTx, systems that partially comprise a wireless transmission path are known.

In the case of mobile communication systems, there are places where wireless communication with an outside base station cannot be performed, such as in an underground shopping center or in a tunnel, and so forth, for example. Small base stations are therefore sometimes provided in these places. The small base stations and outside equipment are connected by optical fiber.

FTTx is a system for accessing a network such as the Internet by using optical fiber. FTTB (Fiber To The Building), FTTH (Fiber To The Home) and so forth, for example, are known as FTTx. A system that employs a wireless transmission path is known as one type of FTTx. In FTTx that uses a wireless transmission path, the central station and base station are connected by means of an optical transmission path, and the base station and terminal are connected by means of a wireless transmission path. Because the base station and terminal are connected by means of a wireless transmission path, the work of laying the optical fiber in an existing building is unnecessary or reduced.

ROF (Radio On Fiber) is known as a technology that integrates optical communication and wireless communication. ROF is disclosed in Japanese Patent Application Laid Open No. H6-070362, for example. The communication network that is adopted by ROF requires a higher carrier frequency than a communication network that uses only an optical transmission path. This is because the S/N ratio of a wireless transmission path is smaller than the S/N ratio of an optical transmission path. Generally, when the communication speed is the same, the carrier frequency of the ROF communication network is high at eight or more times the carrier frequency of the optical communication network.

Generally speaking, the higher the carrier frequency, the more expensive the equipment for building the optical transmission path. For example, when a high frequency electrical signal is converted into an optical signal, a drop in the communication quality resulting from tertiary intermodulation distortion or similar is then a problem. In order to suppress a drop in the communication quality, a high-cost Electrical/Optical converter is required. For this reason, the ROF communication network possesses the drawback that the equipment is expensive.

Moreover, when a ROF communication network uses multiplexing technology such as CDMA (Code Division Multiple Access) and TDMA (Time Division Multiple Access) and so forth, there is the disadvantage that the system is then complex. In addition, the system is extremely complex also when integrating a system in which a central station and terminal devices are connected by using only optical fiber and a system using ROF.

### SUMMARY OF THE INVENTION

An object of the present invention is to simplify and lower the costs of the constitution of a communication system that comprises a wireless transmission path and an optical transmission path.

The communication system relating to the present invention is characterized in that a central station and a base station are connected by using an optical transmission path; the base station and a wireless terminal are connected by using a wireless transmission path; and the frequency of an optical signal transmitted via the optical transmission path is lower than the frequency of a wireless signal transmitted via the wireless transmission path.

In the case of the communication system of the present invention, by using low frequency optical signals and high frequency electrical signals, the costs of building the communication system are reduced without any loss of communication speed.

### BRIEF DESCRIPTION OF THE DRAWINGS

Further objects and advantages of the present invention will be described with reference to the attached drawings below.

FIG. 1 is a block diagram that schematically shows the constitution of a communication system relating to a first embodiment;

FIG. 2 is a block diagram that schematically shows the constitution of a communication system relating to a second embodiment;

FIG. 3 is a block diagram that schematically shows the constitution of a communication system relating to a third embodiment;

FIG. 4 is a block diagram that schematically shows the constitution of a communication system relating to a fourth embodiment;

FIG. 5 is a block diagram that schematically shows the constitution of a communication system relating to a fifth embodiment;

FIG. 6 is a block diagram that schematically shows the constitution of a communication system relating to a sixth embodiment;

FIG. 7 is a block diagram that schematically shows the constitution of a communication system relating to a seventh embodiment; and

FIG. 8 is a block diagram that schematically shows the constitution of a communication system relating to an eighth embodiment.

### DESCRIPTION OF THE PREFERRED EMBODIMENTS

Embodiments of the present invention will be described below by using the drawings. In the drawings, the size, shape, and dispositional relationships of the components are merely shown schematically to an extent permitting an understanding of the invention and the numerical conditions described hereinbelow are only illustrative examples.

First Embodiment

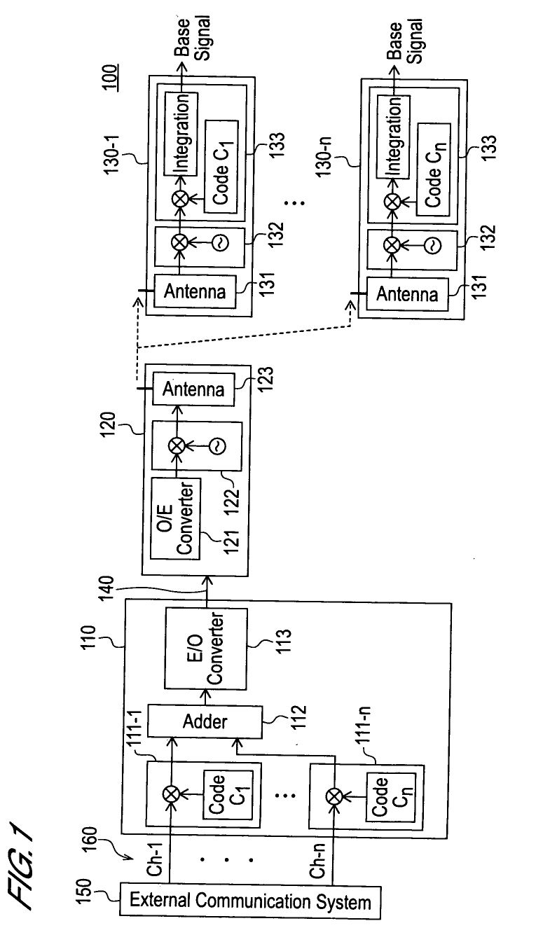

The communication system relating to the first embodiment will be described by using FIG. 1.

As shown in FIG. 1, the communication system 100 of this embodiment comprises a central station 110, a base station 120, wireless terminals 130-1 to 130-n, and an optical fiber 140. This communication system 100 is connected to an external communication system 150 via a communication path 160. FIG. 1 shows only the constitution associated with downlink communication (that is, communication from the central station 110 to the wireless terminals 130-1 to 130-n), the constitution associated with uplink communication being omitted here.

The central station 110 accommodates one or a plurality of base stations 120. The central station 110 transmits a base signal that has been code-division multiplexed to the base station 120 thus accommodated. The central station 110 comprises a plurality of spreaders 111-1 to 111-n, an adder 112, and an E/O converter 113.

The spreaders 111-1 to 111-n receive a base signal (that is, a base band signal) from an external communication system 150 via the communication path 160. A base signal is a signal that has not been carrier-modulated. The communication path 160 comprises the same number of communication channels ch-1 to ch-n as spreaders. The spreaders 111-1 to 111-n use spreading codes C1 to Cn to spectrum-spread the base signal. The spreading codes C1 to Cn are mutually different values.

The adder 112 receives inputs of spectrum-spread base signals from the spreaders 111-1 to 111-n and adds up these signals. A code-division multiplexed base signal is thus generated.

The E/O converter 113 converts the electrical signal inputted by the adder 112 into an optical signal. The multiplexed signal that has been thus converted into an optical signal is then sent to the base station 120 via the optical fiber 140. The communication system of this embodiment transmits the signal thus converted into an optical signal to the base station 120 without subjecting the signal to carrier modulation. Therefore, the signal frequency is lower than that of a carrier-modulated signal. Therefore, unlike a conventional ROF communication system, deterioration of the communication quality resulting from tertiary intermodulation distortion can be ignored. It is therefore possible to employ a low-cost device as the E/O converter 113.

In the case where a plurality of base stations 120 is accommodated, the central station 110 comprises the spreaders 111-1 to 111-n, the adder 112 and the E/O converter 113 for each of the accommodated base stations 120.

The base station 120 accommodates a plurality of wireless terminals 130-1 to 130-n in a corresponding cover area. The base station 120 comprises an O/E converter 121, a carrier modulator 122, and an antenna 123.

The O/E converter 121 converts the optical signal that is input via the optical fiber 140 into an electrical signal. That is, a code-division multiplexed base signal is output as the electrical signal by the O/E converter 121. The carrier modulator 122 carrier-modulates the base signal. That is, the carrier modulator 122 impresses the base signal on the carrier wave. As a result of this modulation, the base signal is converted to a high frequency signal. The method for performing carrier modulation can be freely selected. For example, an intensity modulation method such as Amplitude Modulation (AM), or a phase modulation method such as Phase Shift Keying (PSK), Differentially coherent Phase Shift Keying (DPSK), or Quadrature Phase Shift Keying (QPSK) can be adopted.

An antenna 123 converts a high frequency signal that is input by the carrier modulator 122 into a wireless signal. The wireless signal is transmitted by the antenna 123 to the wireless terminals 130-1 to 130-n. The antenna 123 comprises an amplifier (not shown) for amplifying the amplitude of the high frequency signal. The attainment distance of the wireless signal can be increased by increasing the amplitude.

The wireless terminals 130-1 to 130-n are terminals used by the user. The wireless terminals 130-1 to 130-n may be fixed terminals such as desktop-type personal computers or may be mobile terminals such as notebook-type personal computers, cellular telephones, or PHS (Personal Handyphone System) terminals or these terminals may be mixed. The maximum number of wireless terminals that can be used is the same as the number of spreaders 111-1 to 111-n. The wireless terminals 130-1 to 130-n each comprise an antenna 131, a carrier demodulator 132, and a de-spreader 133.

The antenna 131 receives a wireless signal that has been transmitted by the antenna 123 of the base station 120. The wireless signal thus received is converted into a high frequency electrical signal.

The carrier demodulator 132 receives an input of a high frequency signal from the antenna 131. The carrier demodulator 132 demodulates the high frequency signal by using a signal with the same frequency as the carrier wave. Accordingly, a low frequency code-division multiplexed base signal is restored.

The de-spreader 133 uses the spreading codes Cl to Cn to decode the signal inputted by the carrier demodulator 132. The base signal prior to code-division multiplexing is thus restored. The spreading codes Cl to Cn each have values that are the same as the spreading codes Cl to Cn used by the corresponding spreaders 111-1 to 111-n.

The communication protocol of the wireless terminals 130-1 to 130-n is optional. For example, when the wireless terminals 130-1 to 130-n are computers, a wireless local area network protocol such as CSMA/CA (Carrier Sense Multiple Access with Collision Avoidance) can be used. When the wireless terminals 130-1 to 130-n are cellular phones or PHS terminals or similar, the communication protocol is determined by the telecommunications carrier.

As mentioned earlier, an external communication system 150 supplies a base signal to the central station 110. The external communication system 150 may be a large-scale network such as the Internet or may be a LAN (Local Area Network). In addition, the external communication system 150 may be a system that uses a wired transmission path or a system that uses a wireless transmission path. However, even when a wireless transmission path is used, the signal received by the central station 110 must be a base signal rather than a carrier-modulated signal.

As mentioned above, the communication system of FIG. 1 does not have a constitution for an uplink, that is, for communication in the direction from the wireless terminals 130-1 to 130-n to the central station 110. When uplink communications are performed, each of the wireless terminals 130-1 to 130-n further comprises a single spreader and a single carrier demodulator. In addition, in this case, the base station 120 further comprises a single carrier demodulator and a single E/O converter. In addition, here, the central station 110 further comprises a single E/O converter and a plurality of de-spreaders.

The points of installation of the stations 110 and 120 are determined in accordance with the application of the communication system 100. For example, when the communication system 100 of this embodiment is used for communications in an area into which it is difficult for radio waves to enter such as an underground shopping center or a tunnel, the central station 110 is desirably installed outside the area and the base station 120 within the area. On the other hand, when the communication system 100 is used in order to obviate the need to lay optical fiber in an existing building, the stations 110 and 120 are installed outside the building. In addition, when the communication system 100 is used in order to reduce the laying of optical fiber within an existing building, the central station 110 is installed outside the building, and the base station 120 is installed in the building, for example. In this case, the work involved in building a communication system within the building may only involve the extension of the optical fiber 140 from the central station 110 outside the building to the base station 120 inside the building.

FIG. 1 only shows a constitution that is equivalent to the physical layer of the OSI (Open Systems Interconnection) reference model. However, stations 110 and 120, and the terminals 130-1 to 130-n may have a constitution that is equivalent to a layer above the physical layer. More particularly, the wireless terminals 130-1 to 130-n often require an upper layer constitution.

The operation of the communication system 100 will be described next.

The external communication system 150 transmits base signals to the central station 110 via the communication channels ch-1 to ch-n of the communication path 160. These base signals each correspond to the wireless terminals 130-1 to 130-n. The spreaders 111-1 to 111-n of the central station 110 each carry out a spectrum spreading calculation by using the base signal that is input thereto. The calculation results are added by the adder 112. Accordingly, the base signals inputted by the communication channels ch-1 to ch-n are code-division multiplexed. The code-division multiplexed signal is converted into an optical signal by the E/O converter 113. The optical signal is transmitted to the base station 120 via the optical fiber 140. For example, when the data rate of the communication channels ch-1 to ch-n is 10 Mbps and the chip (that is, the bit length of the spreading codes C1 to Cn) is 64, the chip rate (that is, the communication rate of the stations 110 and 120) is 640 Mbps.

The base station 120 converts the received optical signal into an electrical signal and subjects this signal to carrier modulation. As a result of this modulation, the code-division multiplexed base signal is modulated to produce a high frequency signal. The high frequency signal is transmitted to the wireless terminals 130-1 to 130-n by the antenna 123. As mentioned earlier, because the S/N ratio is small in wireless communication, a frequency that is eight or more times that of optical fiber communication is necessary. Therefore, the frequency of the carrier wave used for the carrier modulation is set at or above 5.12 GHz (that is, eight times 640 MHz).

The wireless terminals 130-1 to 130-n receive a wireless signal by using the antenna 131. The wireless signal is reverted to a carrier-modulated high frequency electrical signal by the antenna 131. In addition, the high frequency electricals signal is reverted to a code-division multiplexed base signal by means of carrier demodulation. Then, a signal that is the same as the base signal input by the communication channels ch-1 to ch-n this base signal is obtained by de-spreading the base signal by using the corresponding spreading codes Cl to Cn. That is, as a result of the de-spreading, each of the wireless terminals 130-1 to 130-n is capable of extracting only the data addressed for each of the wireless terminals 130-1 to 130-n themselves. Then, the wireless terminals 130-1 to 130-n perform processing that corresponds with a layer which is or above the data link layer of the OSI reference model, that is, protocol processing and processing by a communication application. As a result, the final receipt data of the wireless terminals 130-1 to 130-n is obtained.

In the case of a conventional ROF communication system, carrier modulated waves are used not only in a wireless communication path but also in an optical transmission path. Therefore, when the data rate of the communication channels ch-1 to ch-n is 10 Mbps, the frequency of the carrier wave is set at or above 5.12 GHz along with the optical transmission path and the wireless transmission path. Further, when the data rate of the communication channels ch-1 to ch-n is 100 Mbps, the frequency of the carrier wave of the optical transmission path and the wireless transmission path is set at or above 51.2 GHz. That is, with conventional communication systems, it has been necessary to set the optical frequency extremely high. Therefore, as mentioned earlier, with a conventional ROF communication system, it was been necessary to prevent a drop in communication quality resulting from tertiary intermodulation distortion by using a high-cost E/O converter.

Accordingly, in the case of the communication system 100 of this embodiment, a modulated carrier wave is not used for the communication of the optical transmission path. Hence, the communication system 100 is capable of using low frequency optical waves. For this reason, as mentioned earlier, when the data rate of the communication channels ch-1 to ch-n is 10 Mbps, the signal frequency of the optical transmission path is 640 MHz, and, even when the data rate of the communication channels ch-1 to ch-n is 100 Mbps, the signal frequency of the optical transmission path is 6.4 GHz. Therefore, an adequate communication quality can be ensured without using a high-cost E/O converter.

Second Embodiment

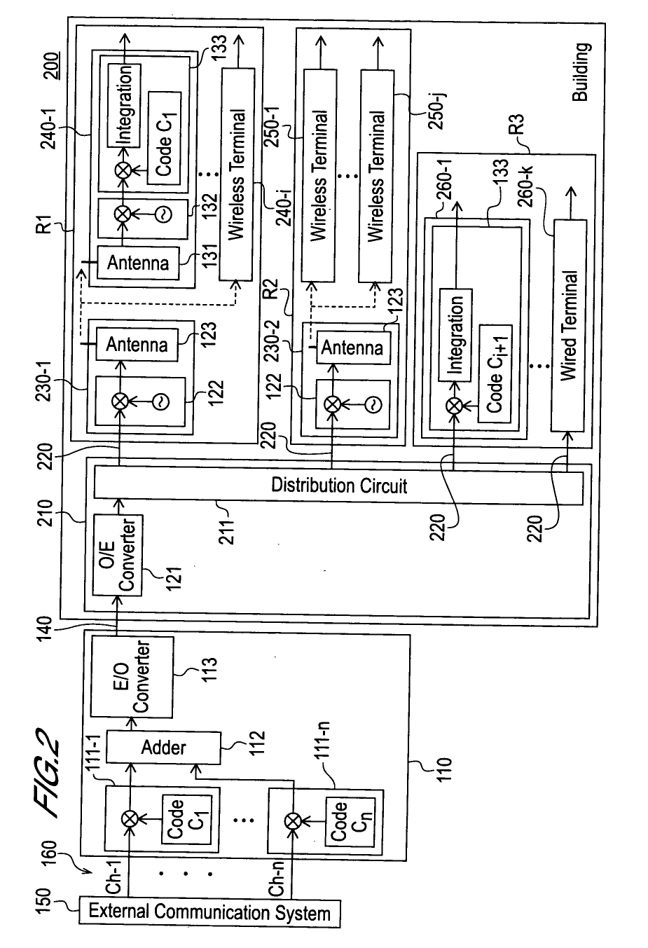

The communication system relating to the second embodiment will now be described by using FIG. 2. In FIG. 2, the same reference symbols as in FIG. 1 have been assigned to the same components as in FIG. 1.

As shown in FIG. 2, the communication system 200 of this embodiment comprises a distributor 210, base stations 230-1 and 230-2, wireless terminals 240-1 to 240-i, 250-1 to 250-j, and wired terminals 260-1 to 260-k. Each of these devices 210 to 260-k is installed in the same building.

The distributor 210 is provided in the building and connected to the central station 110 via the optical fiber 140. The distributor 210 comprises an O/E converter 121 and a distribution circuit 211. The O/E converter 121 converts an optical signal inputted via the optical fiber 140 into an electrical signal. The distribution circuit 211 transmits a base signal inputted by the O/E converter 121 to the base stations 230-1 and 230-2 and to the wired terminals 260-1 to 260-k via electrical transmission paths 220, 220, . . . . That is, the same signal is transmitted to the base stations 230-1 and 230-2 and the wired terminals 260-1 to 260-k.

The type of electrical transmission path 220 is not limited. A twisted pair cable and coaxial cable, and the like, which are used in an Ethernet (registered trademark), for example, can be used as the electrical transmission paths 220.

The base stations 230-1 and 230-2 are installed in each of rooms R1 and R2 which are used by the wireless terminals 240-1 to 240-i and 250-1 to 250-j, for example. The base stations 230-1 and 230-2 each comprise the carrier modulator 122 and the antenna 123. The constitution of the devices 122 and 123 is the same as that of the devices 122 and 123 in the first embodiment. A high frequency signal that is output by the antenna 123 is received by the wireless terminals 240-1 to 240-i.

The constitution of the wireless terminals 240-1 to 240-i and 250-1 to 250-j is the same as that of the wireless terminals 130-1 to 130-n of the first embodiment. That is, the wireless terminals 240-1 to 240-i and 250-1 to 250-j comprise the antenna 131, the carrier demodulator 132, and the de-spreader 133.

The wired terminals 260-1 to 260-k are installed in room R3. Each of the wired terminals 260-1 to 260-k comprises the de-spreader 133.

The respective spreading codes Cl to Cn used by the de-spreader 133 of the terminals 240-1 to 240-i, 250-1 to 250-j, and 260-1 to 260-k are the same values as the respective spreading codes Cl to Cn used by the corresponding spreaders 111-1 to 111-n. The communication protocol of these terminals is optional. In the example of FIG. 2, the wired terminals 260-1 to 260-k are directly connected to the distributor 210. However, when there is the desire to simplify the wiring, the wired terminals 260-1 to 260-k may be connected to the distributor 210 via a suitable network device (a hub, layer 2 switch, router and so forth, for example). In addition, a network device may be used as the wiring from the distributor 210 to the base stations 230-1 and 230-2, and the wired terminals 260-1 to 260-k.

In the example of FIG. 2, two base stations 230-1 and 230-2 output the same signal. However, the communication system 200 can also be constituted so that the base station 230-1 installed in room R1 outputs a wireless signal that corresponds with the wireless terminals 240-1 to 240-i alone, and so that the base station 230-2 installed in room R2 outputs a wireless signal that corresponds with the wireless terminals 250-1 to 250-j alone. In this case, the central station 110 individually code-division multiplexes the base signals corresponding with the wireless terminals 240-1 to 240-i and the base signals corresponding with the wireless terminals 250-1 to 250-j. When code-division multiplexing is carried out individually in correspondence with the base stations 230-1 and 230-2, there may be an overlap between the spreading codes used by the wireless terminals 240-1 to 240-i and the spreading codes used by the wireless terminals 250-1 to 250-j. When the spreading codes overlap, if processing to discriminate the base stations 230-1 and 230-2 is also executed, it is possible to prevent the distribution of transmitted information to wireless terminals that are not transmission destinations.

The communication system 200 of this embodiment does not subject an optical signal to carrier modulation, and hence, similarly to the communication system 100 of the first embodiment, there is no need to use a high-cost E/O converter. The communication system 200 can therefore be built at a low cost.

In addition, the communication system 200 of this embodiment does not subject an optical signal to carrier modulation, and hence the wired terminals 260-1 to 260-k are capable of performing de-spreading as is without subjecting a received signal to carrier demodulation. Therefore, the costs of the wired terminals 260-1 to 260-k are reduced.

Furthermore, it is possible to perform batchwise code-division multiplexing of the signals transmitted to the wireless terminals 240-1 to 240-i and 250-1 to 250-j and the signals transmitted to the wired terminals 260-1 to 260-k, and hence the equipment of the central station 110 is small-scale and inexpensive.

Wireless interference throughout the building can be suppressed by installing the base station 230 in each room and performing wireless communication in only the corresponding room.

Third Embodiment

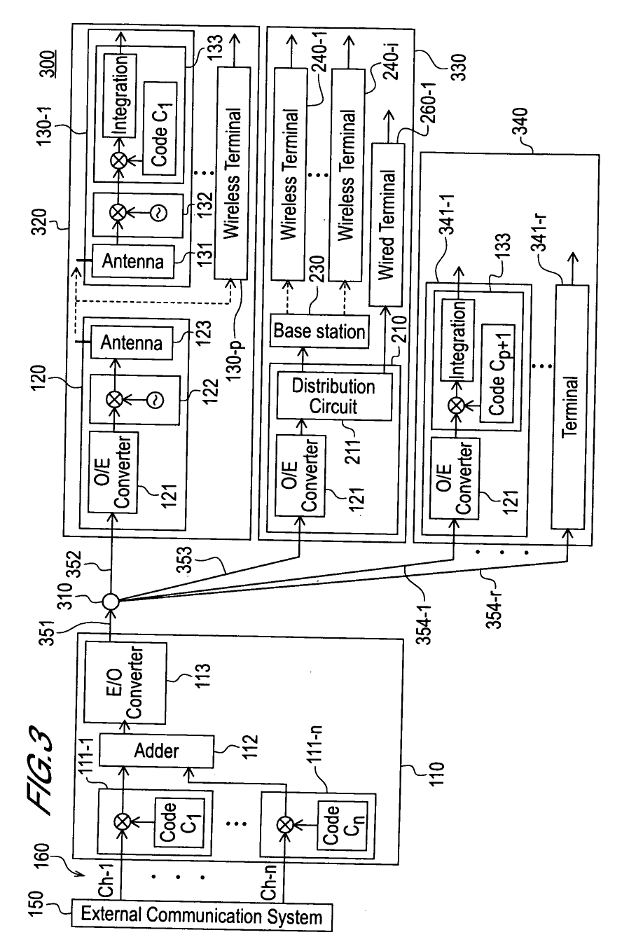

The communication system relating to the third embodiment will now be described by using FIG. 3. In FIG. 3, the same reference symbols as in FIGS. 1 and 2 have been assigned to the same components as in FIGS. 1 and 2.

As shown in FIG. 3, a communication system 300 of this embodiment transmits an optical signal to areas 320, 330 and 340 by using an optical distributor 310 and optical transmission paths 351, 352, 353, and 354-1 to 354-r.

The optical distributor 310 receives an input of an optical signal from the central station 110 via the optical transmission path 351 and outputs the inputted optical signal to the optical transmission paths 352, 353, and 354-1 to 354-r. An optical coupler, for example, can be used as the optical distributor 310.

The network which is provided in area 320 comprises the base station 120 and the wireless terminals 130-1 to 130-p as per the first embodiment (see FIG. 1).

The network which is provided in area 330 comprises the distributor 210, base stations 230 and terminals 240-1 to 240-i as per the second embodiment (see FIG. 2).

The network which is provided in area 340 comprises terminals 341-1 to 341-r. The terminals 341-1 to 341-r are connected to optical transmission paths 354-1 to 354-r. Each of the terminals 341-1 to 341-r comprises the O/E converter 121 and the de-spreader 133.

The maximum number n of the data that is code-division multiplexed by the central station 110 is the same as the total number of terminals 130-1 to 130-p, 240-1 to 240-i, and 341-1 to 341-r.

In the system 300 of this embodiment, the optical distributor 310 and the areas 320 to 340 are connected by an optical transmission path. By using the optical transmission path, the transmission distance can be extended beyond that obtained when an electrical transmission path such as a coaxial cable is used. Therefore, even when the areas 320 to 340 are separate from one another, the areas 320 to 340 can be accommodated within a single central station 110.

In the case of the communication system 300 of this embodiment, the optical signal is not subjected to carrier modulation. Therefore, a carrier demodulator is not required in area 340. Hence, the communication system 300 can be built at low cost.

In addition, because the communication system 300 of this embodiment does not subject the optical signal to carrier modulation, a wired terminal is able to perform de-spreading on a received signal without subjecting same to carrier demodulation. The cost of the wired terminal is thus reduced.

Moreover, the signal transmitted to the wireless terminal and the signal transmitted to the wired terminal can be code-division multiplexed batchwise, and hence the equipment of the central station 110 is small-scale and inexpensive.

Wireless interference throughout the building can be suppressed by installing the base station 230 in each room and performing wireless communication in only the corresponding room.

Fourth Embodiment

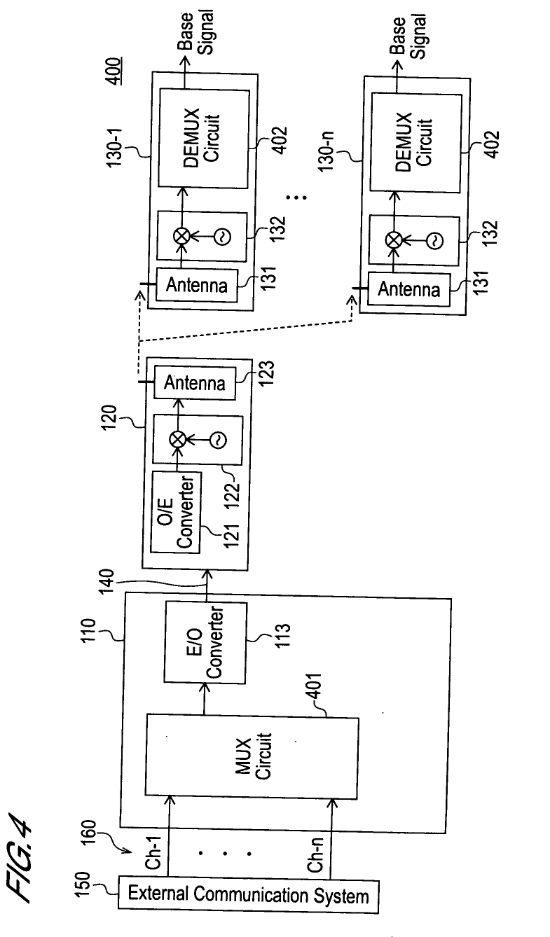

The communication system relating to the fourth embodiment will now be described by using FIG. 4. In FIG. 4, the same reference symbols as in FIG. 1 have been assigned to the same components as in FIG. 1.

The communication system 400 relating to this embodiment differs from the communication system 100 relating to the first embodiment in that time division multiplexing technology is employed.

The central station 110 comprises a MUX circuit 401. The MUX circuit 401 receives a base signal from the external communication system 150 via the communication channels ch-1 to ch-n of the communication path 160. Then, the MUX circuit 401 combines data units such as packets, frames or cells from the base signal thus received, and time-division multiplexes these combined data units. The multiplexed signal is converted into an optical signal by the E/O converter 113. For example, when the communication speed of each of the communication channels ch-1 to ch-n is 10 Mbps, the speed of the signal that is output by the MUX circuit 401 is 320 Mbps. Therefore, the processing speed of the E/O converter 113 must also be 320 Mbps.

The wireless terminals 130-1 to 130-n comprises a DEMUX circuit 402. The DEMUX circuit 402 extracts only the signal which is addressed thereto from the multiplexed signal thus input by the carrier demodulator 132.

The other processing (carrier modulation and carrier demodulation, and so forth) is the same as the corresponding processing of the first embodiment.

The communication system 400 of this embodiment does not subject the optical signal to carrier modulation, and hence, as with the communication system 100 of the first embodiment, does not require the use of a high-cost E/O converter. This communication system 400 can therefore be built at low cost.

Fifth Embodiment

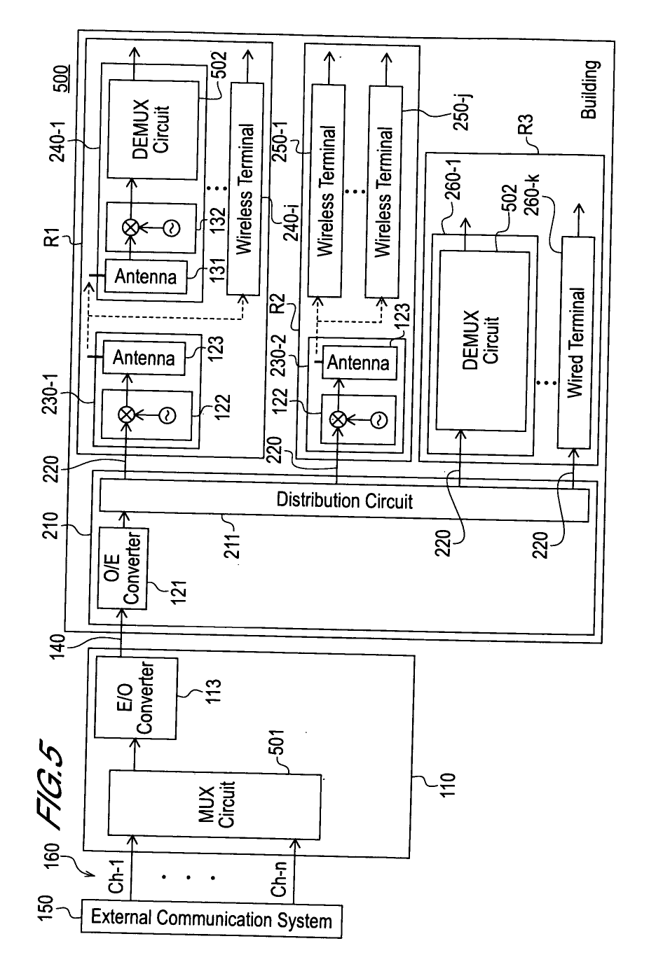

The communication system relating to the fifth embodiment will now be described by using FIG. 5. In FIG. 5, the same reference symbols as in FIG. 2 have been assigned to the same components as in FIG. 2.

The communication system 500 relating to this embodiment differs from the communication system 200 relating to the second embodiment in that time division multiplexing technology is employed.

The central station 110 comprises a MUX circuit 501. The MUX circuit 501 receives a base signal from the external communication system 150 via the communication channels ch-1 to ch-n of the communication path 160. Then, the MUX circuit 501 combines data units such as packets, frames or cells from the base signal thus received, and time-division multiplexes these combined data units. The multiplexed signal is converted into an optical signal by the E/O converter 113.

The terminals 240-1 to 240-i, 250-1 to 250-j, and 260-1 to 260-k comprise a DEMUX circuit 502. The DEMUX circuit 502 extracts only the signal which is addressed thereto from the multiplexed signal that is input by the carrier demodulator 132.

The other processing (carrier modulation and carrier demodulation, and so forth) is the same as the corresponding processing of the first embodiment.

The communication system 500 of this embodiment does not subject the optical signal to carrier modulation, and hence, as with the communication system 200 of the second embodiment, does not require the use of a high-cost E/O converter. This communication system 500 can therefore be built at low cost.

In addition, because the communication system 500 of this embodiment does not subject the optical signal to carrier modulation, the wired terminals 260-1 to 260-k are able to perform de-spreading as is without subjecting the received signal to carrier demodulation. Therefore, the cost of the wired terminals 260-1 to 260-k is reduced.

Furthermore, it is possible to perform batchwise code-division multiplexing of the signals transmitted to the wireless terminals 240-1 to 240-i and 250-1 to 250-j and the signals transmitted to the wired terminals 260-1 to 260-k, and hence the equipment of the central station 110 is small-scale and inexpensive.

Wireless interference throughout the building can be suppressed by installing the base station in each room and performing wireless communication in only the corresponding room.

Sixth Embodiment

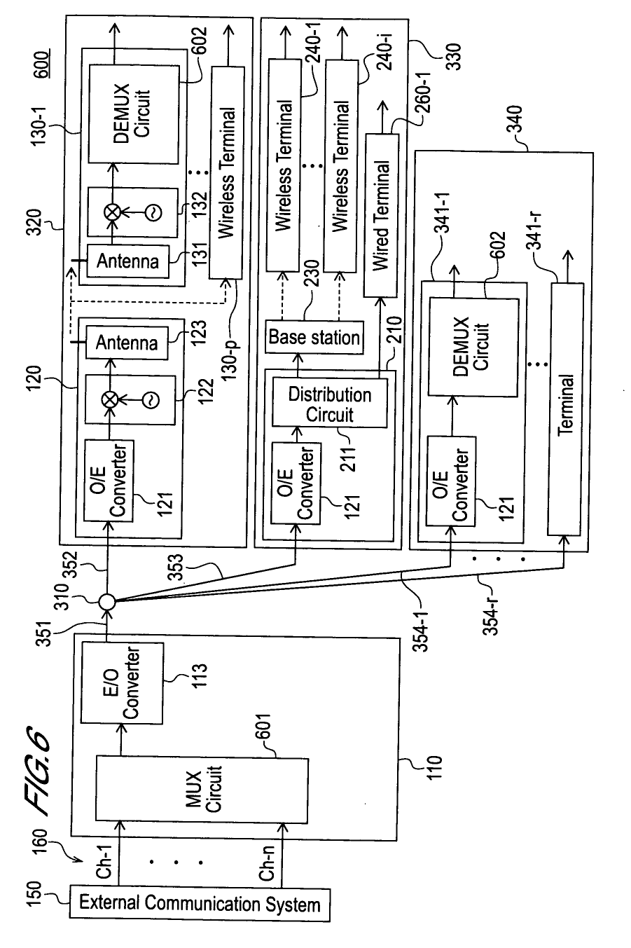

The communication system relating to the sixth embodiment will now be described by using FIG. 6. In FIG. 6, the same reference symbols as in FIG. 3 have been assigned to the same components as in FIG. 3.

The communication system 600 relating to this embodiment differs from the communication system 300 relating to the third embodiment in that time division multiplexing technology is employed.

The central station 110 comprises a MUX circuit 601. The MUX circuit 601 receives a base signal from the external communication system 150 via the communication channels ch-1 to ch-n of the communication path 160. Then, the MUX circuit 601 combines data units such as packets, frames or cells from the base signal thus received, and time-division multiplexes these combined data units. The multiplexed signal is converted into an optical signal by the E/O converter 113.

The terminals 130-1 to 130-p, 240-1 to 240-i, and 341-1 to 341-r comprise the DEMUX circuit 502. The DEMUX circuit 502 extracts only the signal which is addressed thereto from the multiplexed signal that is input by the carrier demodulator 132.

The other processing (carrier modulation and carrier demodulation, and so forth) is the same as the corresponding processing of the third embodiment.

The communication system 600 of this embodiment does not subject the optical signal to carrier modulation, and hence, as with the communication system 300 of the third embodiment, does not require the use of a high-cost E/O converter. This communication system 600 can therefore be built at low cost.

In addition, because the communication system 600 of this embodiment does not subject the optical signal to carrier modulation, the wired terminals are able to perform de-spreading as is without subjecting the received signal to carrier demodulation. Therefore, the cost of the wired terminals is reduced.

Furthermore, it is possible to perform batchwise code-division multiplexing of the signals transmitted to the wireless terminals and the signals transmitted to the wired terminals, and hence the equipment of the central station 110 is small-scale and inexpensive.

Wireless interference throughout the building can be suppressed by installing the base station 230 in each room and performing wireless communication in only the corresponding room.

Seventh Embodiment

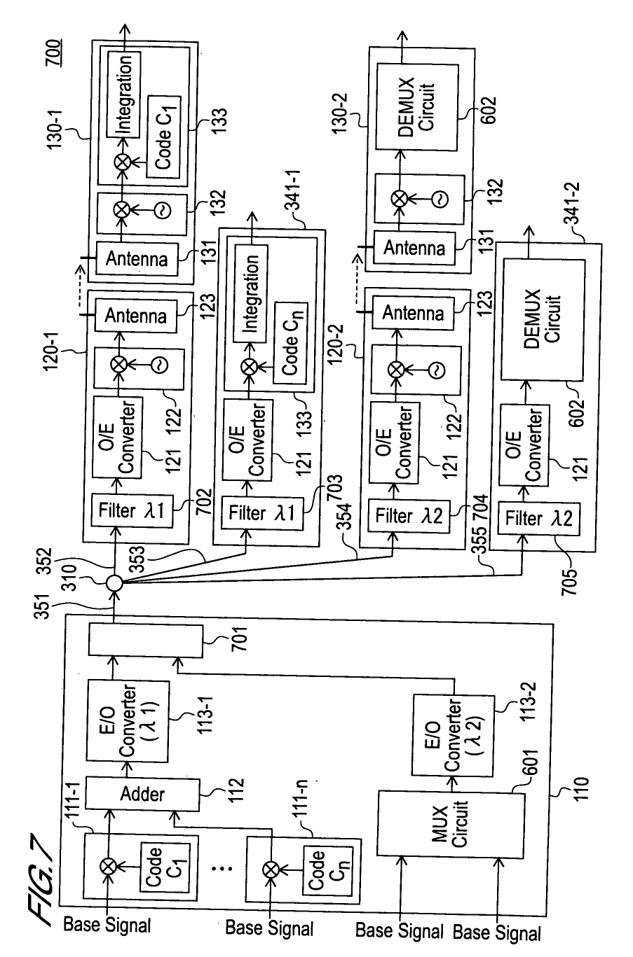

The communication system relating to the seventh embodiment will now be described by using FIG. 7. In FIG. 7, the same reference symbols as in FIGS. 3 and 6 have been assigned to the same components as in FIG. 3 and 6.

The communication system 700 relating to this embodiment makes combined usage of code division multiplexing technology and time division multiplexing technology. Code-division multiplexed signals and time-division multiplexed signals are subjected to wavelength division multiplexing.

In the central station 110, the spreaders 111-1 to 111-n and the adder 112 generate a code-division multiplexed electrical signal as per the third embodiment. In addition, a MUX circuit 411 generates a time-division multiplexed electrical signal as per the sixth embodiment. An E/O converter 113-1 converts a code-division multiplexed electrical signal into an optical signal of wavelength λ1. The E/O converter 113-2 converts the time-division multiplexed electrical signal into an optical signal of wavelength λ2. A photo multiplexer 701 multiplexes the optical signals that are input by the E/O converters 113-1 and 113-2 and outputs this multiplexed signal to the optical transmission path 351.

The optical distributor 310 sends the optical signal thus received via the optical transmission path 351 to the base stations 120-1 and 120-2 and the terminals 341-1 and 341-2. That is, the same optical signal is transmitted to the base stations 120-1 and 120-2 and the terminals 341-1 and 341-2.

The base station 120-1 comprises a wavelength filter 702. The wavelength filter 702 extracts the optical signal of wavelength λ1, that is, the code-division multiplexed optical signal, from the wavelength-division multiplexed optical signal. The code-division multiplexed signal thus extracted is sent to the wireless terminal 130-1 via signal processing that is the same as that of the third embodiment.

The terminal 341-1 comprises a wavelength filter 703. The wavelength filter 703 extracts the optical signal of wavelength λ1, that is, the code-division multiplexed optical signal, from the wavelength-division multiplexed optical signal. The code-division multiplexed signal thus extracted is inverted to the base signal via signal processing that is the same as that of the third embodiment.

The base station 120-2 comprises a wavelength filter 704. The wavelength filter 704 extracts the optical signal of wavelength λ2, that is, the time-division multiplexed optical signal, from the wavelength-division multiplexed optical signal. The time-division multiplexed signal thus extracted is then sent to the wireless terminal 130-2 via signal processing that is the same as that of the sixth embodiment.

The terminal 341-2 comprises the wavelength filter 705. The wavelength filter 705 extracts the optical signal of the wavelength λ2, that is, the time-division multiplexed optical signal, from the wavelength-division multiplexed optical signal. The time-division multiplexed optical signal thus extracted is then inverted to the base signal via signal processing that is the same as that of the sixth embodiment.

The communication system 700 of this embodiment does not subject the optical signal to carrier modulation, and hence, as with the communication systems 300 and 600, does not require the use of a high-cost E/O converter. This communication system can therefore be built at low cost.

In addition, because the communication system 700 of this embodiment does not subject the optical signal to carrier modulation, the wired terminals are able to perform de-spreading as is without subjecting the received signal to carrier demodulation. Therefore, the cost of the wired terminals is reduced.

Furthermore, it is possible to perform batchwise multiplexing of the signals transmitted to the wireless terminals and the signals transmitted to the wired terminals, and the code-division multiplexed signals and time-division multiplexed signals can be transmitted batchwise. The costs required to build a system are therefore low and the flexibility of the system constitution is high.

Eighth Embodiment

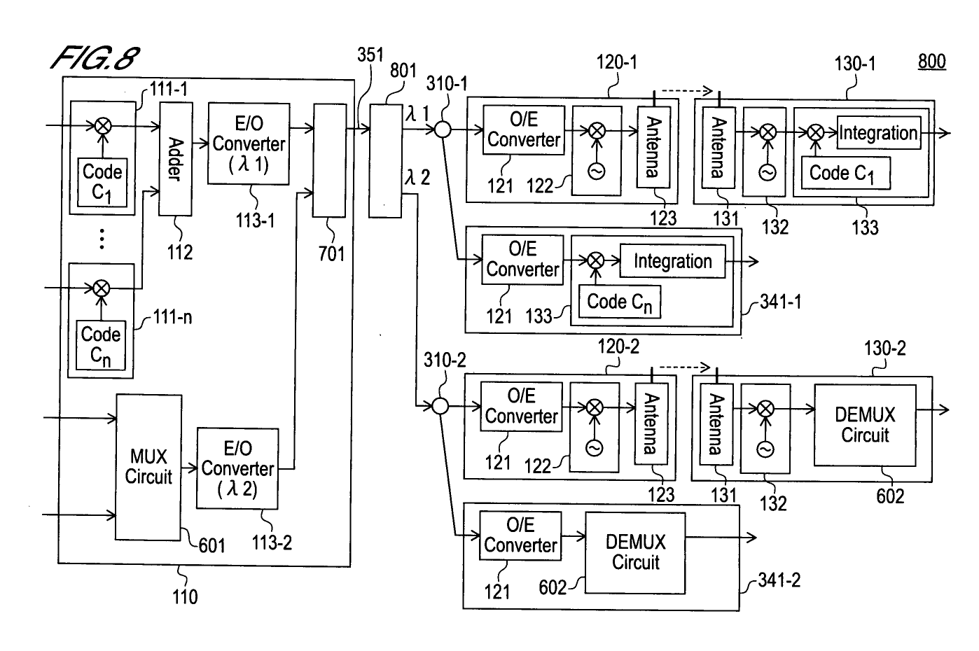

The communication system relating to the eighth embodiment will now be described by using FIG. 8. In FIG. 8, the same reference symbols as in FIG. 7 have been assigned to the same components as in FIG. 7.

The communication system 800 relating to this embodiment makes combined usage of code division multiplexing technology and time division multiplexing technology. Code-division multiplexed signals and time-division multiplexed signals are subjected to wavelength division multiplexing.

The constitution of the central station 110 is the same as that for the central station in the seventh embodiment.

A photo demultiplexer 801 divides the optical signal received via the optical transmission path 351 into an optical signal of wavelength λ1, that is, the code-division multiplexed optical signal, and an optical signal of a wavelength λ2, that is, the time-division multiplexed optical signal. The photo demultiplexer 801 can be constituted by an optical filter, for example.

The optical distributor 310-1 sends a code-division multiplexed optical signal to the base station 120-1 and the terminal 341-1. That is, the same optical signal is transmitted to the base station 120-1 and the terminal 341-1.

The optical distributor 310-2 sends a time-division multiplexed optical signal to the base station 120-2 and the terminal 341-2. That is, the same optical signal is transmitted to the base station 120-2 and the terminal 341-2.

The constitution of the base stations 120-1 and 120-2 and of the terminals 341-1 and 341-2 is the same as that for the base stations and terminals of the seventh embodiment except for the fact that the filters 702 to 705 are not provided.

In the case of the communication system 700 relating to the seventh embodiment mentioned above, the wavelength-division multiplexed optical signal is sent to all the receivers 120-1, 120-2, 341-1, and 341-2. On the other hand, with the communication system 800 relating to the eighth embodiment, the optical signal of wavelength λ1 is sent only to the base station 120-1 and terminal 341-1, and the optical signal of wavelength λ2 is sent only to the base station 120-2 and terminal 341-2. For this reason, in the case of the communication system 800, the respective intensities of the optical signals received by the receivers 120-1 and 120-2 and 341-1 and 341-2 are large in comparison with those of the communication system 700. This is because the divisional loss can be diminished by reducing the transmission destinations. Therefore, the maximum permissible transmission distance of the communication system 800 can be increased in comparison with that of the communication system 700.

Signal loss varies according to the type of optical device being used. For example, while a 3-decibel signal loss is produced each time the optical distributor performs division into two, the signal loss of the optical filter that constitutes the photo demultiplexer is one decibel. Therefore, compared with the communication system 700, the communication system 800 of this embodiment exhibits a small signal loss of two decibels. The two decibels of the signal loss are five kilometers when calculated as the maximum permissible transport distance.

As shown in FIG. 8, the central station 110 relating to this embodiment comprises a single code-division multiplexing system and a single time-division multiplexing system. However, it is also possible to provide the code-division multiplexing systems and time-division multiplexing systems in a total of three or more systems. In addition, it is possible to provide only a plurality of code-division multiplexing systems and to provide only a plurality of time-division multiplexing systems. However, each of these systems use mutually different optical frequencies. So too in such cases, as per the communication system 800 in FIG. 8, the maximum permissible transport distance is greater than for the communication system 700.

The communication system 800 of this embodiment does not subject the optical signal to carrier modulation, and hence, as with the communication systems 300 and 600, does not require the use of a high-cost E/O converter. This communication system can therefore be built at low cost.

In addition, because the communication system 800 of this embodiment does not subject the optical signal to carrier modulation, the wired terminals are able to perform de-spreading as is without subjecting the received signal to carrier demodulation. Therefore, the cost of the wired terminals is reduced.

Furthermore, it is possible to perform batchwise multiplexing of the signals transmitted to the wireless terminals and the signals transmitted to the wired terminals, and the code-division multiplexed signals and time-division multiplexed signals can be transmitted batchwise. The costs required to build a system are therefore low and the flexibility of the system constitution is high.

The present invention can also be adopted in a system that performs multiplexing by using only wavelength-division multiplex technology in the central station 110.

In addition, the present invention can also be adopted in a communication system that does not carry out signal multiplexing.

What is claimed is:

1. A communication system, wherein:
a central station and a base station are connected by using an optical transmission path;
the base station and a wireless terminal are connected by using a wireless transmission path; and
the frequency of an optical signal transmitted via the optical transmission path is lower than the frequency of a wireless signal transmitted via the wireless transmission path.

2. The communication system according to claim 1, wherein:
an optical signal that has not been carrier-modulated is used as the optical signal transmitted via the optical transmission path; and
a wireless signal that has been carrier-modulated is used as the wireless signal transmitted via the wireless transmission path.

3. The communication system according to claim 2, wherein the central station comprises an Electrical to Optical converter that converts an electrical signal into an optical signal and outputs the optical signal to the optical transmission path.

4. The communication system according to claim 3, wherein the central station comprises a multiplexing circuit that subjects a plurality of electrical base signals to code-division multiplexing, time-division multiplexing or wavelength-division multiplexing and then outputs the multiplexed signal to the Electrical to Optical converter.

5. The communication system according to claim 2, wherein the base station comprises:
an Optical to Electric converter that converts an optical signal that is input via the optical transmission path into an electrical signal;
a carrier modulator that carrier-modulates the electrical signal that is input by the Optical to Electric converter; and
a transmitter antenna that converts the electrical signal that is input by the carrier modulator into a wireless signal.

6. The communication system according to claim 2, wherein the wireless terminal comprises:
a receiver antenna that converts a wireless signal into an electrical signal; and
a carrier demodulator that carrier-demodulates the electrical signal that is input by the receiver antenna.

7. The communication system according to claim 6, wherein the wireless terminal comprises a demultiplexing circuit that subjects a carrier-demodulated electrical signal to code-division demultiplexing, time-division demultiplexing or wavelength-division demultiplexing.

8. The communication system according to claim 2, further comprising an electrical distributor that converts an optical signal that is input via the optical transmission path into an electrical signal and then distributes this electrical signal.

9. The communication system according to claim 8, wherein the base station comprises:
a carrier modulator that carrier-modulates the electrical signal that is input by the electrical distributor; and
a transmitter antenna that converts the electrical signal that is input by the carrier modulator into a wireless signal.

10. The communication system according to claim 8, wherein a plurality of the base station is connected to the electrical distributor.

11. The communication system according to claim 8, wherein one or a plurality of the base station and one or a plurality of wired terminals are connected to the electrical distributor.

12. The communication system according to claim 2, further comprising an optical distributor that distributes the optical signal that is input via the optical transmission path.

13. The communication system according to claim 12, wherein a plurality of the base station is connected to the optical distributor.

14. The communication system according to claim 12, wherein one or a plurality of the base station and one or a plurality of wired terminals are connected to the optical distributor.

15. The communication system according to claim 12, wherein one or a plurality of the base station and one or a plurality of electrical distributors are connected to the optical distributor.

16. The communication system according to claim 15, wherein a plurality of the base station is connected to the electrical distributor.

17. The communication system according to claim 12, wherein the optical signal is a signal that is produced by subjecting a plurality of optical signals to wavelength-division multiplexing.

18. The communication system according to claim 17, wherein each of the base stations comprises a frequency filter for wavelength-demultiplexing the multiplexed signal.

19. The communication system according to claim 17, further comprising a demultiplexer for wavelength-dividing the optical signal and then outputting a wavelength-divided optical signal to each of the plurality of optical distributors corresponding with each wavelength.

20. The communication system according to claim 17, wherein each of the plurality of wavelength-division multiplexed optical signals is a code-division multiplexed signal or a time-division multiplexed signal.
